(19) United States
(12) Patent Application Publication
(10) Pub. No.: US 2025/0033134 A1
(43) Pub. Date: Jan. 30, 2025

(54) SPOT WELDING GUN AND SYSTEM AND METHOD FOR AUTONOMOUSLY CALIBRATING WELDING QUALITY BY USING THE SAME

(71) Applicants: HYUNDAI MOTOR COMPANY, Seoul (KR); KIA CORPORATION, Seoul (KR); NAWOOTEC CO., LTD., Incheon (KR)

(72) Inventors: Seung Ho Lee, Incheon (KR); Taekue Lee, Incheon (KR)

(73) Assignees: HYUNDAI MOTOR COMPANY, Seoul (KR); KIA CORPORATION, Seoul (KR); NAWOOTEC CO., LTD., Incheon (KR)

(21) Appl. No.: 18/523,530

(22) Filed: Nov. 29, 2023

(30) Foreign Application Priority Data
Jul. 27, 2023 (KR) 10-2023-0097906

(51) Int. Cl. B23K 11/11; B23K 31/12; G05D 3/12

(52) U.S. Cl. CPC B23K 11/115; B23K 31/125; G05D 3/12

(57) ABSTRACT

A system for autonomously calibrating welding quality by using a spot welding gun includes a spot welding gun configured to fix a welding target during a welding process. The spot welding gun is configured to precisely measure a welding indentation depth and perform autonomous welding quality calibration in response to an applied control signal. The system also includes welding robot equipped with the spot welding gun and configured to move to a designated welding point position, a welding controller configured to control a welding current and a welding time of the spot welding gun and inspect welding quality in real time by monitoring the welding indentation depth and dynamic resistance during the welding process, and a welding quality manager configured to receive a welding quality inspection result from the welding controller, transmit a welding condition feedback change, and control the autonomous welding quality calibration.

### CROSS-REFERENCE TO RELATED APPLICATION

This application claims priority to and the benefit of Korean Patent Application No. 10-2023-0097906 filed in the Korean Intellectual Property Office on Jul. 27, 2023, the entire contents of which are incorporated herein by reference.

### BACKGROUND

### (a) Technical Field

The present disclosure relates to a spot welding gun and a system and method for autonomously calibrating welding quality by using the same. More particularly, the present disclosure relates to a spot welding gun, which is used to precisely measure welding quality in real time and autonomously calibrate the welding quality, and to a system and method for autonomously calibrating welding quality by using the same.

### (b) Description of the Related Art

In general, a production line in a vehicle factory operates a large number of welding robots for automatically performing spot welding to join a plurality of members.

Spot welding refers to a welding method of fixing a welding target to upper and lower welding tips provided on a spot welding gun mounted on a welding robot, pressing the welding target, and applying high-voltage current to the welding target. The welding operation is continuously and repeatedly performed at a plurality of welding points.

However, as the welding robot repeats the welding operation over time, welding quality may be changed because of a change in material (e.g., of the welding target) or equipment (e.g., spot welding gun).

For example, FIG. 17 illustrates factors causing welding quality change during a welding process of a lower fixed-type spot welding gun in the related art.

With reference to FIG. 17, because of a change in material or thickness of a panel, a position of the panel set between the upper and lower welding tips of the welding gun may be raised or lowered from a normal position. In this case, an excessive or insufficient amount of welding indentation occurs, which causes welding separation and excessive spatter, and thus deterioration in vehicle external appearance quality.

In addition, in the case of equipment, as the spot welding gun performs the repeated welding operation, welding quality is changed by a change in length caused by abrasion of the welding tip, a change in length of a shank, bending of a welding gun arm, and sagging of the welding gun. In addition, there is a problem in that welding quality is changed or varies in accordance with the skill of a welding robot teaching operator when working variables occur because of changes in material/thickness of the welding target.

However, in the related art, there is no function for inspecting, by using the spot welding gun, welding quality problems or defects such as the occurrence of excessive welding indentation, welding separation, welding spatter or autonomously calibrating (e.g., and effectuating) a change in welding quality.

Meanwhile, in the related art, the welding quality is identified by measuring a current value supplied from a welding controller and measuring a resistance value outputted after the welding process. However, during an actual mass-production process, various fluctuations of resistance values occur on a welding part, which makes it difficult to accurately predict welding quality by measuring the resistance value.

Therefore, in the vehicle factory, a welding quality manager manually inspects the welding quality off-line. Alternatively, a separate welding inspection process is provided in a production line, and an operator manually inspects the welding quality using a semi-destructive sampling method. However, when the operator manually performs the semi-destructive inspection, there is a likelihood that a vehicle with a welding defect is delivered to a post process location because of human error, which causes deterioration in product reliability such as recall of finished vehicles.

In addition, there is a problem in that, when defective welding quality occurs, welding conditions are managed depending on the experience of the welding quality manager, regardless of data, which causes delays in ensuring welding quality and causes high costs during the development stage of new vehicles and/or in the event of the occurrence of factors that change welding quality.

The above information disclosed in this Background section is provided only to enhance understanding of the background of the disclosure. Therefore, the Background section may contain information that does not form the prior art that is already known to a person of ordinary skill in the art.

### SUMMARY

The present disclosure has been made in an effort to provide a spot welding gun having a mechanical part for fixing a reference surface of a welding part and precisely measuring a welding indentation depth of a welding target during a spot welding process.

The present disclosure has also been made in an effort to provide a system and a method for autonomously calibrating welding quality, which are capable of improving reliability of welding quality by using the spot welding gun. Specifically, the system and method include evaluating welding quality in real time by measuring a welding indentation depth of a welding target and include autonomously calibrating the changed welding quality.

An embodiment of the present disclosure provides a spot welding gun for autonomously calibrating welding quality. The spot welding gun includes: a first welding tip on a welding gun upper part and a second welding tip on a welding gun lower part; a robot mounting bracket configured to mount the first welding tip and the second welding tip on a welding robot; a welding pressing unit configured to press a welding target by using compressed air supplied from an air compressor and precisely measure a welding indentation depth of a welding part by using an encoder connected directly to a rear side of the welding pressing unit during a welding process; a welding transformer configured to supply high current required during the welding process; an air balance cylinder configured to prevent deformation of a reference measurement surface of the welding part by implementing an equalizing function for moving the second welding tip in a rectilinear upward/downward direction by using the compressed air; and a linear guide unit configured to assist a rectilinear upward/downward movement of the second welding tip.

In addition, the air balance cylinder may perform the equalizing function for raising or lowering the welding gun lower part using a minimum force until the second welding tip of the welding gun lower part touches the welding target when the welding target is higher or lower than a reference height.

In addition, the air balance cylinder may include: an electric proportional pressure control valve configured to adjust, by using a piston, a main pressure of the compressed air to a low pressure corresponding to the minimum force by which whether the rising second welding tip touches a lower portion of the welding target is recognized; a piston position sensor configured to monitor a motion of the piston and recognize whether the second welding tip touches the welding target; and a pressure detection sensor configured to support feedback control for minimum force derivation by transmitting pressures, which are measured using first and second ports P1 and P2 embedded in the air balance cylinder, to the electric proportional pressure control valve.

In addition, the pressure detection sensor may measure air pressure introduced into the air balance cylinder through the P1 and measure exhaust pressure discharged to the outside through the P2, and the pressure detection sensor may provide feedback to the electric proportional pressure control valve.

In addition, the electric proportional pressure control valve may receive feedback related to the air pressure in the P1 and the exhaust pressure in the P2 and control the movement of the second welding tip with the derived minimum force. The electric proportional pressure control valve may stop the movement of the second welding tip when it is detected by the piston position sensor that movement of the piston has stopped.

In addition, the piston position sensor may have a sensor wire vertically installed inside the air balance cylinder and detect whether the piston is moved by using a Hall effect generated between magnets installed on the piston.

In addition, the welding pressing unit may include a roller screw configured to convert a rotational motion of a magnetic type servo motor into a rectilinear motion of a driving shaft and may include an encoder connected in series to a rear end of the driving shaft and configured to precisely measure a position of the first welding tip installed at a tip of the driving shaft.

In addition, the encoder may measure a distance D of the first welding tip from the welding pressing unit in accordance with the rectilinear movement of the directly connected driving shaft. A welding start distance value D1 and a welding completion distance value D2 may be measured in a state in which the first welding tip touches an upper surface of the welding target. The welding indentation depth may be calculated as a value made by subtracting D1 from D2.

In addition, the linear guide unit may include: a linear guide rail provided in the rectilinear upward/downward direction; a linear guide bearing having a dual structure and configured to move the second welding tip along the linear guide rail; and a linear guide rail brake configured to fix a position of the second welding tip to precisely measure the welding indentation depth.

In addition, the linear guide rail brake may include: friction member units configured to come into contact with two opposite sides of the linear guide rail and generate a braking force by friction; friction member sliding units configured to guide the friction member units in a direction of the linear guide rail; piston driving parts configured to apply brake pressure to the friction member units; and origin returning units configured to return the friction member units, which have completed the measurement of the welding indentation depth, to an origin using springs.

In addition, the linear guide rail brake may securely fix the welding gun lower part by setting the braking force to a value higher than an upper portion pressing force generated by the welding pressing unit during the welding process.

Another embodiment of the present disclosure provides a system for autonomously calibrating welding quality by using a spot welding gun. The system includes a spot welding gun configured to constitute a mechanical part that fixes a welding target during a welding process so that a reference measurement surface of a welding part is not deformed. The spot welding gun is configured to precisely measure a welding indentation depth and perform autonomous welding quality calibration in response to an applied control signal. The system also includes a welding robot equipped with the spot welding gun and configured to move to a designated welding point position. The system also includes an air compressor configured to supply high-pressure compressed air for pressing the welding part of the spot welding gun. The system also includes a welding controller configured to control a welding current and a welding time of the spot welding gun on the basis of an initial welding condition and inspect welding quality in real time by monitoring the welding indentation depth and dynamic resistance measured by the spot welding gun during the welding process. The system also includes a welding quality manager configured to receive a welding quality inspection result from the welding controller, transmit a welding condition feedback change according to dissatisfaction of reference value conditions of the welding indentation depth and the dynamic resistance, and control the autonomous welding quality calibration.

In addition, the welding quality manager may store a minimum force and a minimum air pressure as setting values in consideration of a welding gun orientation of the spot welding gun, which varies depending on a plurality of welding point positions set to the welding target, by using a minimum force derivation feedback algorithm for implementing an equalizing function for moving a welding gun lower part in a rectilinear upward/downward direction.

In addition, the welding controller may simultaneously raise the welding gun lower part with a minimum force and lower a welding gun upper part by means of a welding gun pressing unit to move the welding gun lower part and the welding gun upper part until the welding gun lower part and the welding gun upper part come into contact with each other with the welding target interposed therebetween by inputting a minimum air pressure, which is set by the welding quality manager, to an air balance cylinder. The welding controller may press upper and lower portions of the welding target in a force equilibrium state by increasing an operating pressure, by which the air balance cylinder raises the welding gun lower part, in accordance with an upper portion pressing force of the welding pressing unit.

In addition, the welding controller may measure a welding current and a dynamic resistance R in real time while maintaining a pressing force for the welding gun upper part and a pressing force for the welding gun lower part during the welding process using the spot welding gun. The welding controller may measure a welding indentation depth by subtracting a welding start distance value D1, which indicates that the welding gun upper part touches an upper portion of the welding target, from a welding completion distance value D2.

In addition, when the welding indentation depth and a dynamic resistance upper limit value do not satisfy a preset first reference value and a preset second reference value, the welding controller may determine that a welding separation defect (NG) or an excessive spatter and welding defect (NG) occurs. The welding controller may also transmit a welding quality inspection result to the welding quality manager. The welding controller may also change at least one welding condition among a current value, a pressing force, and a welding time according to a welding condition feedback change of the welding quality manager.

In addition, in the event of the welding separation defect (NG), the welding quality manager may perform a welding current application again with 50% of the initial welding condition and transmit a welding condition feedback change message for increasing at least one of the current value and the pressing force to the welding controller. In the event of the excessive spatter and welding defect (NG), the welding quality manager may transmit a welding condition feedback change message for decreasing at least one of the current value, the pressing force, and the welding time to the welding controller.

Still another embodiment of the present disclosure provides a method of autonomously calibrating welding quality by using a spot welding gun. The method includes: moving, by a welding controller, a spot welding gun to a designated welding point position by means of a welding robot, and simultaneously raising a welding gun lower part with a minimum force by inputting a minimum air pressure to an air balance cylinder and lowering a welding gun upper part by means of a welding gun pressing unit to move the welding gun lower part and the welding gun upper part come into contact with each other with a welding target interposed therebetween. The method also includes a welding step of pressing upper and lower portions of the welding target in a force equilibrium state by increasing an operating pressure, by which the air balance cylinder raises the welding gun lower part, in accordance with an upper portion pressing force of the welding pressing unit. The method also includes measuring a welding current and dynamic resistance in real time while pressing the welding gun upper part during a welding process, and precisely measuring a welding indentation depth by using an encoder connected directly to a rear side of the welding pressing unit. The method also includes transmitting a welding quality inspection result to a welding quality manager and requesting autonomous welding quality calibration when the welding indentation depth and a dynamic resistance upper limit value do not satisfy a preset first reference value and a preset second reference value. The method also includes analyzing, by the welding quality manager, the welding quality inspection result and transmitting a welding condition feedback change message, which corresponds to a welding separation defect (NG) or an excessive spatter and welding defect (NG), to a welding controller.

In addition, the welding quality manager may perform a minimum force derivation feedback algorithm for an equalizing function for moving the welding gun lower part in a rectilinear upward/downward direction. The minimum force derivation feedback algorithm may include: inputting, by the welding quality manager, a welding gun lower part weight and a welding gun orientation with respect to a designated welding point; inputting a minimum air pressure of the air balance cylinder corresponding to the welding gun lower part weight and monitoring whether the air balance cylinder operates by means of a piston position sensor; determining that the welding gun lower part cannot be moved when a motion is not detected by the piston position sensor and increasing air pressure to a predetermined level; determining current air pressure to a minimum air pressure Pm by which the welding gun lower part is movable when the motion is detected by the piston position sensor; and setting the minimum air pressure Pm and a minimum force of the welding gun lower part according to the welding point position and a spot welding gun orientation condition as a setting value and storing the setting value.

In addition, analyzing the welding quality inspection result may include determining that the welding separation defect (NG) occurs when the welding indentation depth is less than a lower limit value of the first reference value and the dynamic resistance upper limit value exceeds an upper limit value of the second reference value, performing a welding current application again with 50% of an initial welding condition, and creating a welding condition feedback change message for increasing at least one of a current value and a pressing force. Analyzing the welding quality inspection results may also include determining that the excessive spatter& welding defect (NG) occurs when the welding indentation depth exceeds an upper limit value of the first reference value and the dynamic resistance upper limit value is less than a lower limit value of the second reference value, and creating a welding condition feedback change message for decreasing at least one of the current value, the pressing force, and a welding time.

According to an embodiment of the present disclosure, the welding quality may be inspected in real time by precisely measuring the dynamic resistance and the welding indentation depth by using the spot welding gun during the welding process. Also, the autonomous calibration may be performed on the changed welding quality, thereby preventing a product defect and improving reliability of welding quality.

In addition, it is possible to prevent deformation of a welding reference surface, which is caused by a material and a facility, by using the linear guide unit and the air balance cylinder of the spot welding gun and using the equalizing function for moving the welding gun lower part in the rectilinear upward/downward direction.

In addition, the spot welding gun is provided with the linear guide rail brake for preventing the welding gun lower part from sagging during a welding process, and the spot welding gun is provided with the encoder directly applied to the driving shaft of the welding pressing unit, which makes it possible to precisely measure the welding indentation depth in real time during the welding process.

### BRIEF DESCRIPTION OF THE DRAWINGS

FIG. 1 is a view schematically illustrating a configuration of a spot welding system for autonomously calibrating welding quality according to an embodiment of the present disclosure.

FIG. 2 is a view illustrating a configuration of a spot welding gun for autonomously calibrating welding quality according to an embodiment of the present invention.

FIG. 3 is a view schematically illustrating configurations of an air balance cylinder and a linear guide unit according to an embodiment of the present disclosure.

FIG. 4 is a view illustrating an example in which a reference surface of a welding part is deformed by a fluctuation of a height of the welding part during a spot welding process in the related art.

FIG. 5 is a view illustrating an example of an application of an equalizing function of a spot welding gun lower part according to an embodiment of the present disclosure.

FIG. 6 is a flowchart illustrating a minimum force derivation method using a minimum force derivation feedback algorithm according to an embodiment of the present disclosure.

FIG. 7 is a view illustrating a minimum force derivation method for each welding gun direction using a minimum force derivation feedback algorithm according to an embodiment of the present disclosure.

FIG. 8 is a view illustrating a method of controlling a pressing force for a welding gun lower part when the equalizing function according to the embodiment of the present disclosure is applied.

FIG. 9 is a view illustrating a method of implementing an equalizing function for preventing deformation of a welding object during a spot welding process according to an embodiment of the present disclosure.

FIG. 10 is a view illustrating a configuration of a mechanical part for precisely measuring a welding indentation depth according to an embodiment of the present disclosure.

FIG. 11 is a view illustrating a welding quality evaluation method according to a correlation between the welding indentation depth and the welding quality according to an embodiment of the present disclosure.

FIG. 12 is a view schematically illustrating a structure for operating a linear guide rail brake according to an embodiment of the present disclosure.

FIG. 13 is a graph illustrating a method of inspecting welding quality in real time by using the spot welding gun according to an embodiment of the present disclosure.

FIG. 14 is a view illustrating the comparison between dynamic resistance graphs and welding indentation depths in a normal welding state, a welding separation state, and an excessive spatter & welding state according to an embodiment of the present disclosure.

FIG. 15 is a flowchart schematically illustrating a method of autonomously calibrating welding quality by using the spot welding gun according to an embodiment of the present disclosure.

FIG. 16 is a flowchart schematically illustrating an autonomous welding quality calibration logic of a welding quality manager according to an embodiment of the present disclosure.

FIG. 17 is a view illustrating welding quality change factors during a welding process of a lower fixed-type spot welding gun in the related art.

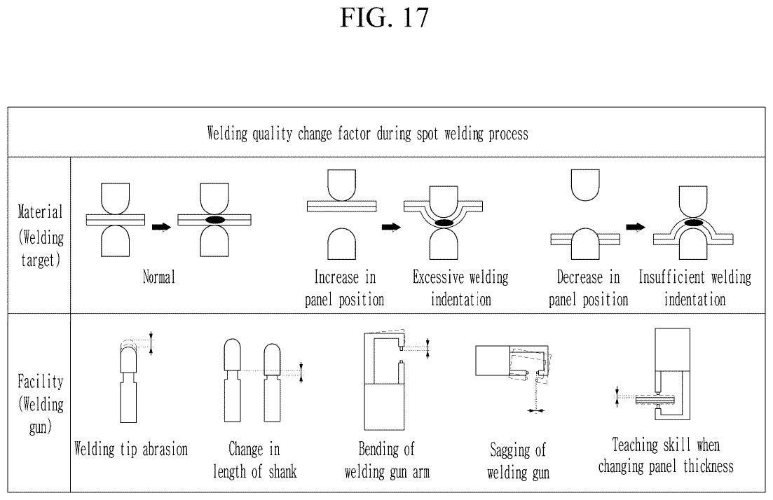

### DETAILED DESCRIPTION OF THE EMBODIMENTS

Hereinafter, embodiments of the present disclosure are described in detail with reference to the accompanying drawings so that those of ordinary skill in the technical field to which the present disclosure pertains may practice the described embodiments.

The terms used herein are merely for the purpose of describing specific embodiments, and are not intended to limit the present disclosure. The singular expressions used herein are intended to include the plural expressions unless the context clearly dictates otherwise. It is to be understood that the term “comprise (include)” and/or “comprising (including)” used in the present specification means that the features, the integers, the steps, the operations, the constituent elements, and/or component are present, but the presence or addition of one or more of other features, integers, steps, operations, constituent elements, components, and/or groups thereof is not excluded. The term “and/or” used herein includes any one or all the combinations of listed related items.

Throughout the specification, the terms such as “first,” “second,” “A,” “B,” “(a),” “(b),” and other numerical terms may be used herein only to describe various elements, but these elements should not be limited by these terms. These terms are used only for the purpose of discriminating one constituent element from another constituent element, and the nature, the sequences, or the orders of the constituent elements are not limited by the terms.

Throughout the specification, when one constituent element is described as being “connected” or “coupled” to another constituent element, it should be understood that one constituent element can be connected or coupled directly to another constituent element, and an intervening constituent element can also be present between the constituent elements. When one constituent element is described as being “connected directly to” or “coupled directly to” another constituent element, it should be understood that no intervening constituent element is present between the constituent elements.

Throughout the specification, the terms used herein are used for the purpose of describing particular embodiments only and are not intended to limit the present disclosure. Singular expressions include plural expressions unless clearly described as different meanings in the context. When a component, device, element, or the like of the present disclosure is described as having a purpose or performing an operation, function, or the like, the component, device, or element should be considered herein as being “configured to” meet that purpose or perform that operation or function.

In addition, it is understood that one or more of the following methods or aspects thereof may be carried out by at least one controller. The term “controller” may refer to a hardware device including a memory and a processor. The memory is configured to store program instructions, and the processor is specially programmed to execute the program instructions to perform one or more processes described below in more detail. The controller may control operations of units, modules, components, devices, or the like, as described herein. In addition, it is understood that the following methods may be carried out by an apparatus including the controller as well as one or more other components, as should be recognized by those of ordinary skill in the art.

A spot welding gun and a system and method for autonomously calibrating welding quality by using the same according to an embodiment of the present disclosure is described in detail with reference to the drawings.

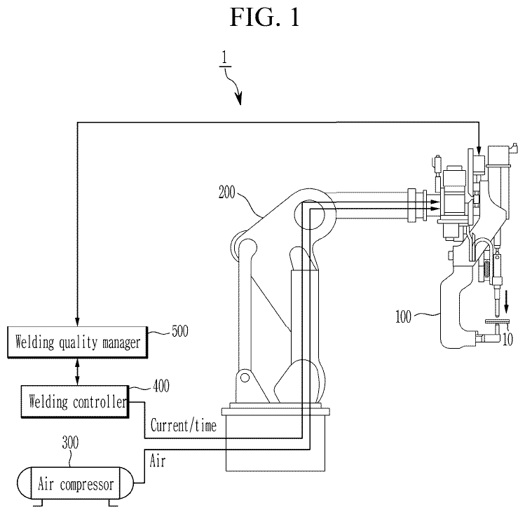

FIG. 1 is a view schematically illustrating a configuration of a spot welding system for autonomously calibrating welding quality according to an embodiment of the present disclosure.

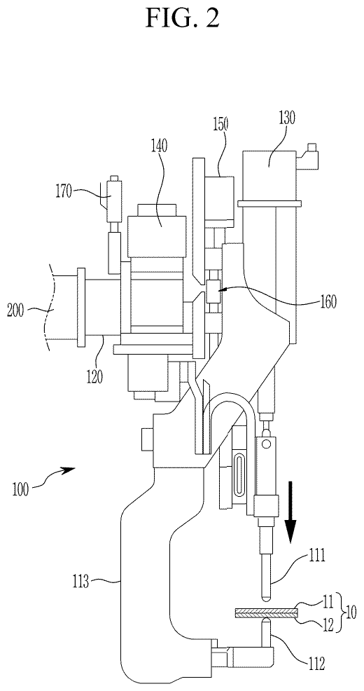

With reference to FIG. 1, a system 1 for autonomously calibrating welding quality according to an embodiment of the present disclosure is installed to automatically perform spot welding to join welding targets (e.g., vehicle body panels) 10 continuously supplied in a production line in a vehicle factory. The welding targets 10 may include an upper panel 11 and a lower panel 12 and be set by a jig or conveying means for a welding operation (See FIG. 2).

The system 1 for autonomously calibrating welding quality includes a spot welding gun 100, a welding robot 200, an air compressor 300, a welding controller 400, and a welding quality manager 500.

The spot welding gun 100 constitutes a mechanical part that fixes the welding target 10 during the spot welding process so that a reference measurement surface of a welding part is not deformed. Accordingly, the spot welding gun 100 precisely measures a welding indentation depth (thickness) and autonomously calibrates welding quality in response to an applied control signal.

The welding robot 200 mounts the spot welding gun 100 on an arm tip of an articulating structure and moves the spot welding gun 100 to a designated welding point position.

The air compressor 300 supplies high-pressure compressed air for pressing the welding part of the spot welding gun 100.

The welding controller 400 controls a welding current and a welding time of the spot welding gun 100 on the basis of a preset welding condition (hereinafter, referred to as an ‘initial welding condition’) and inspects the welding quality in real time by monitoring the welding indentation depth and the dynamic resistance measured by the spot welding gun 100 during the welding process. In this case, the welding controller 400 may determine whether normal welding quality is implemented by collectively evaluating a result of inspecting the monitored welding indentation depth and dynamic resistance. In addition, the welding controller 400 may include a robot control means and control a kinematic posture (e.g., motion) of the welding robot 200 for the spot welding.

The welding quality manager 500 transmits a welding condition feedback change according to the dissatisfaction of (e.g., failure to satisfy) reference value conditions of the welding indentation depth and the dynamic resistance depending on the welding quality inspection result received from the welding controller 400 and controls the autonomous welding quality calibration.

Therefore, the welding controller 400 may control the autonomous welding quality calibration by changing at least one of the current value, the pressing force, and the welding time, which are set as the initial welding conditions, in response to the welding condition feedback change.

The system 1 for autonomously calibrating spot welding quality according to an embodiment of the present disclosure precisely measures, in real time, the welding indentation depth of the welding target by using the spot welding gun 100 during the spot welding process. Additionally, the system 1 for autonomously calibrating spot welding quality autonomously calibrates the welding quality changed by changes in the setting position of the welding target and/or the equipment (e.g., spot welding gun 100), thereby improving the reliability of the welding quality.

The spot welding gun 100 according to an objective of the present disclosure is implemented to precisely measure, in real time, the welding indentation depth (thickness) of the welding target during the spot welding process, and finely adjusts a height of a welding gun lower part, thereby autonomously calibrating the change in welding quality.

FIG. 2 is a view illustrating a configuration of the spot welding gun for autonomously calibrating welding quality according to an embodiment of the present disclosure.

With reference to FIG. 2, the spot welding gun 100 according to an embodiment of the present disclosure includes a first welding tip 111 provided at an upper side of the welding gun, a second welding tip 112 provided at a lower side of the welding gun, and a robot mounting bracket 120 configured to mount the first welding tip 111 and the second welding tip 112 on the welding robot 200. Additionally, the spot welding gun 100 includes a welding pressing unit 130 configured to press the welding target 10 by using the compressed air supplied from the air compressor 300 and precisely measure the welding indentation depth of the welding part by using an encoder connected directly to a rear side of the welding pressing unit 130 during the welding process. The spot welding gun 100 also includes a welding transformer (TR) 140 configured to supply necessary high current during the welding process, an air balance cylinder 150 configured to prevent deformation of the reference measurement surface of the welding part by implementing an equalizing function for moving the second welding tip 112 in a rectilinear upward/downward direction by using the compressed air, and a linear guide unit 160 configured to guide rectilinear upward/downward movements of the second welding tip 112. In addition, the spot welding gun 100 may further include a cooling unit 170 configured to cool the first welding tip 111 and the second welding tip 112 by performing valve control (ON/OFF) controlling a flow of coolant and/or air during the welding process.

The first welding tip 111 disposed on an upper side is vertically connected to the welding pressing unit 130.

The second welding tip 112 disposed on a lower side is connected to the air balance cylinder 150 that performs the equalizing function by means of a C-shaped gun body 113 and the linear guide unit 160.

The first welding tip 111 and the second welding tip 112 respectively come into contact with the upper panel 11 and the lower panel 12 of the welding target 10 during the spot welding process.

Hereinafter, throughout the specification, the first welding tip 111 may be referred to as a welding gun upper part, and the second welding tip 112 and the gun body 113 are referred to as a welding gun lower part. However, the term “upper part” and “lower part” should be understood as meaning the position/direction in which the panels 11 and 12 and the welding tips 111 and 112 are placed when viewed based on FIG. 2, and the direction is not limited thereto.

The welding robot 200 is equipped with the spot welding gun 100 in which the welding gun lower part fixing type, moves to a designated welding point, and is fixed in a state in which the second welding tip 112 is in contact with the lower panel 12 of the welding target 10.

The welding pressing unit 130 presses the upper panel 11 by lowering the first welding tip 111 in a state in which the second welding tip 112 is fixed to a lower portion of the lower panel 12. In this case, the spot welding gun 100 fixes (e.g., contacts) and presses the welding target 10 by using the first welding tip 111 and the second welding tip 112.

In order to precisely measure the welding indentation depth of the welding target 10, the welding pressing unit 130 is configured as a mechanical part including a pressing actuator having a combination of a roller screw and a magnetic type servo motor. A detailed description of the welding pressing unit is provided below.

In the state in which the welding target 10 is fixed and pressed by the first welding tip 111 and the second welding tip 112, the welding transformer 140 may convert welding current, which is supplied from the welding controller 400, to high current suitable for the spot welding, and supply the high current to the first welding tip 111 and/or second welding tip 112.

Meanwhile, the spot welding gun 100 according to an embodiment of the present disclosure may precisely measure the welding indentation depth during the process of welding the welding target 10. In order to precisely measure the welding indentation depth, the following two conditions need to be satisfied in advance.

As a first condition, the reference measurement surface of the welding part for measuring the welding indentation depth need not be deformed.

As a second condition, a configuration of a mechanical part capable of measuring an accurate position without causing a sag of the lower part of the spot welding gun 100 (i.e., the second welding tip) is required during the process of measuring the welding indentation depth.

Hereinafter, the first condition is described.

The spot welding gun 100 according to an embodiment of the present disclosure includes the air balance cylinder 150 and the linear guide unit 160 as mechanical parts for preventing the reference measurement surface of the welding target 10 from being deformed during the welding process.

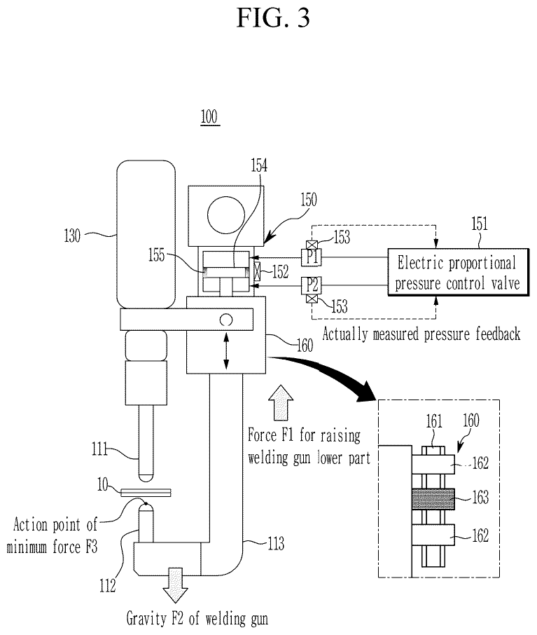

FIG. 3 is a view schematically illustrating configurations of the air balance cylinder and the linear guide unit according to an embodiment of the present disclosure.

With reference to FIG. 3, the air balance cylinder 150 includes an electric proportional pressure control valve 151 configured to adjust, by using a piston 154, a main pressure (e.g., 5 bar or higher) of the high-pressure compressed air to a low pressure corresponding to a minimum force F3 by which whether the second welding tip 112, which is rising, touches (comes into contact with) the lower portion of the welding target 10 may be recognized. The balance cylinder 150 also includes a piston position sensor 152 configured to detect a motion of the piston and recognize whether the second welding tip 112 touches the welding target 10, and a pressure detection sensor 153 configured to support feedback control for the minimum force derivation by transmitting pressures, which are actually measured through first and second ports P1 and P2 embedded in the air balance cylinder 150, to the electric proportional pressure control valve 151.

The linear guide unit 160 guides the rectilinear upward/downward movements of the second welding tip 112 in conjunction with the air balance cylinder 150 and fixes the second welding tip 112 so that the second welding tip 112 does not move during the process of measuring the welding indentation depth.

The linear guide unit 160 may include a linear guide rail 161 provided in the rectilinear upward/downward direction, linear guide bearings 162 configured to move the second welding tip 112 along the linear guide rail 161, and a linear guide rail brake 163 configured to fix a position of the second welding tip 112 to precisely measure the welding indentation depth.

Hereinafter, the equalizing function of the spot welding gun 100 for preventing the deformation welding reference surface even though the position of the welding target 10 is changed and/or the equipment is changed is described according to the first condition.

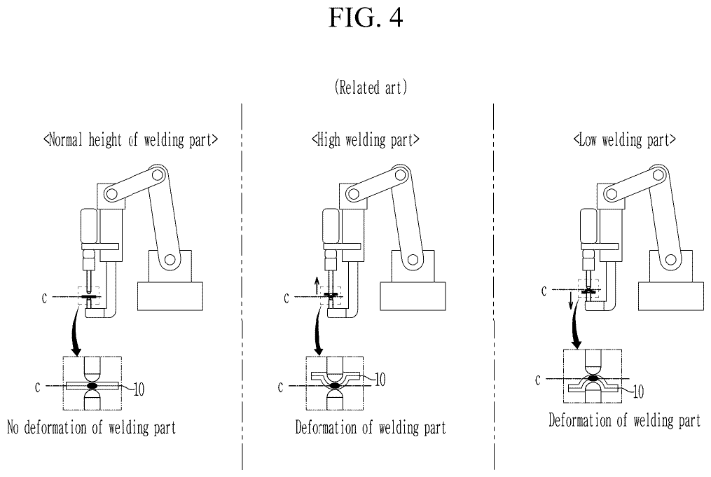

First, FIG. 4 is a view illustrating an example in which a reference surface of a welding part is deformed by a fluctuation of a height of the welding part during a spot welding process in the related art.

With reference to FIG. 4, as described above, the welding robot in the related art performs spot welding while moving a spot welding gun of a lower welding tip fixing type to a plurality of welding points in accordance with teaching conditions. In this case, the welding target 10 is not deformed during the spot welding process in case that the welding target 10 is positioned at normal height coincident with a reference measurement surface c. However, when the height of the welding target is changed or the equipment is changed, the welding quality is changed, and the welding reference surface is deformed by a pressing force of the welding robot (i.e., a pressing force of the welding pressing unit). In addition, in case that high pressure is applied by the welding gun upper part because of the structural characteristics of the spot welding gun of the lower welding tip fixing type, the welding reference surface may be deformed by sagging of the welding gun lower part.

When the reference surface of the welding part is deformed because the change in height of the welding target and the change in equipment as described above, there is a problem in that the welding indentation depth cannot be accurately measured.

Therefore, the spot welding gun 100 according to an embodiment of the present disclosure adopts the equalizing function of the second welding tip 112 at the lower side using the electric proportional pressure control valve 151, the piston position sensor 152, and the pressure detection sensor 153 included in the air balance cylinder 150. Therefore, control is performed to prevent the deformation of the welding reference surface even though the position of the welding target 10 is changed and/or the equipment is changed.

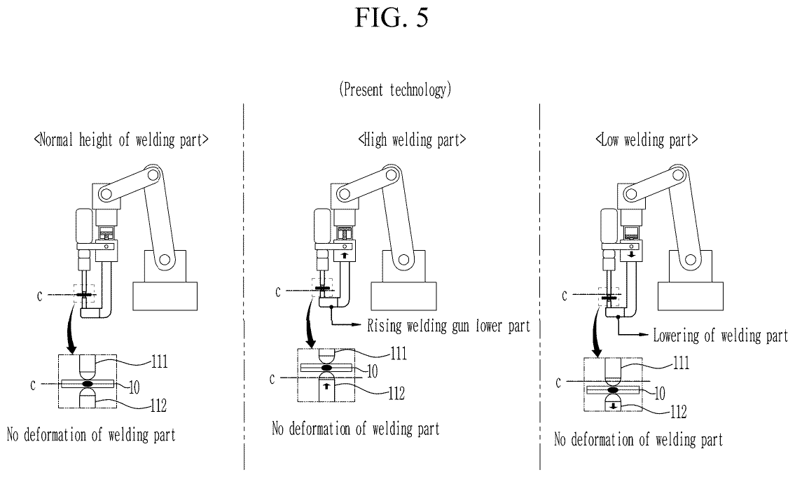

Next, FIG. 5 is a view illustrating an example of an application of the equalizing function of the spot welding gun lower part according to an embodiment of the present disclosure.

With reference to FIG. 5, in case that the welding target 10 is normally positioned at the reference height, the air balance cylinder 150 of the spot welding gun 100 according to an embodiment of the present disclosure performs the normal welding, and the welding part is not deformed.

In addition, even in case that the welding target 10 is higher or lower than the reference height, the air balance cylinder 150 performs the equalizing function for raising or lowering the lower second welding tip 112 by using the minimum force F3 until the lower second welding tip 112 touches the welding target 10, thereby preventing the deformation of the welding part.

In this case, the pressure detection sensor 153 measures air pressure introduced into the air balance cylinder 150 through the first port P1 and measures exhaust pressure discharged to the outside through the second port P2, and the pressure detection sensor 153 provides feedback to the electric proportional pressure control valve 151.

The electric proportional pressure control valve 151 receives feedback related to the air pressure in P1 and exhaust pressure in P2 from the pressure detection sensor 153 and controls the movement of the second welding tip 112 by using the derived minimum force F3. Further, when a state in which the air balance cylinder 150 is stopped is detected by the piston position sensor 152, the electric proportional pressure control valve 151 may determine that the second welding tip 112 touches the welding target 10, and the electric proportional pressure control valve 151 may stop the movement of the second welding tip 112.

As described above, even though the position of the welding target 10 is changed and/or the equipment is changed, the spot welding gun 100 according to an embodiment of the present disclosure may compensate for the change by means of the equalizing function using the air balance cylinder 150 and the electric proportional pressure control valve 151, the piston position sensor 152, and the pressure detection sensor 153 of the air balance cylinder 150. Accordingly, deformation of the welding reference surface during the normal welding process may be prevented.

Meanwhile, in order to implement the equalizing function, it is necessary to find in advance the minimum force that prevents the deformation of the welding surface when the second welding tip 112 touches the welding target 10.

With reference back to FIG. 3, in order to implement the equalizing function, the air balance cylinder 150 detects a time point of the touch of the second welding tip 112 on the welding target 10 and sets the minimum force F3 for preventing the deformation of the welding target 10.

For example, the minimum force F3 may be set to a setting value derived by a minimum force derivation feedback algorithm of the welding quality manager 500 that supports autonomous welding quality calibration control of the welding controller 400.

The welding quality manager 500 derives the minimum force F3 by finding a minimum air pressure that may move the air balance cylinder 150 by using input conditions, i.e., a weight of the second welding tip 112, i.e., a weight of the welding gun lower part and a spot welding gun direction (spot welding gun posture) with respect to the welding point of the welding target 10. The minimum force F3 is a small unit of force exerted when the second welding tip 112 comes into contact with the welding target 10, and the minimum force F3 may be calculated on the basis of Equation 1 below.

$$F 3 = F 2 - F 1 = m * g - A * Pm \qquad ( Equation 1 )$$

Here, F3 represents a minimum force, A represents a piston area of the air balance cylinder, Pm=represents a minimum air pressure capable of moving the welding gun lower part, F1=A*Pm represents a force of the air balance cylinder, and F2=m*g (gravity of the welding gun lower part)*cosT.

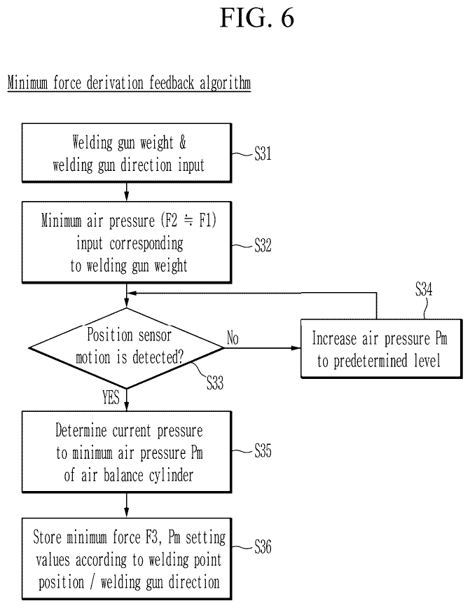

Meanwhile, FIG. 6 is a flowchart illustrating a minimum force derivation method using a minimum force derivation feedback algorithm according to an embodiment of the present disclosure.

With reference to FIG. 6, the welding quality manager 500 inputs the welding gun lower part weight including the second welding tip 112 and the welding gun direction or orientation of the spot welding gun 100 with respect to the designated welding point as start conditions of the minimum force derivation feedback algorithm (S31). In this case, the welding gun orientation may be acquired from a multi-axis angle value of posture control information of the welding robot 200 that moves the spot welding gun 100 to the welding point.

The welding quality manager 500 inputs minimum air pressure (F2≈F1) of the air balance cylinder 150 corresponding to the welding gun lower part weight (S32) and monitors whether the air balance cylinder 150 operates on the basis of whether a motion of the piston position sensor 152 is made (ON/OFF) (S33).

In this case, when the motion of the piston position sensor 152 is not detected (S33: NO), the welding quality manager 500 determines that the second welding tip 112 cannot be moved by the air balance cylinder 150 and increases the air pressure of the air balance cylinder 150 to a predetermined level until the air balance cylinder 150 moves (S34).

In contrast, when the motion is detected by the piston position sensor 151 (S33; YES), the welding quality manager 500 determines the current air pressure to the minimum air pressure Pm of the air balance cylinder 150 that may move the second welding tip 112 (S35).

The welding quality manager 500 sets the Pm and the minimum force F3 of the second welding tip 112, according to the condition of the inputted welding point position and the inputted spot welding gun orientation, to setting values and stores the setting values (S36).

Meanwhile, with the above-mentioned method, the welding quality manager 500 may derive and store the setting values of the minimum force F3 and Pm in consideration of the welding gun orientation of the spot welding gun that varies depending on the plurality of welding point positions set to the welding target 10.

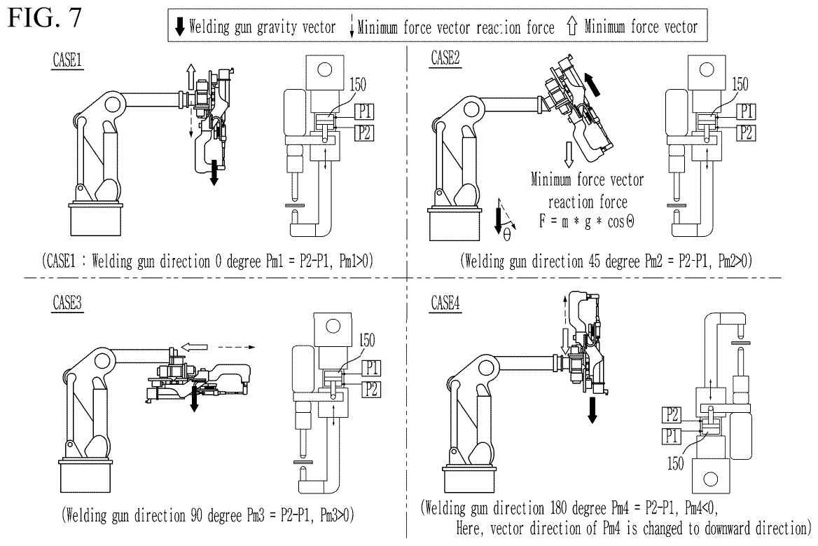

For example, FIG. 7 is a view illustrating a minimum force derivation method for each welding gun orientation using a minimum force derivation feedback algorithm according to an embodiment of the present disclosure.

With reference to FIG. 7, as in CASES 1-4, a minimum force vector direction of the minimum force F3 for moving the air balance cylinder 150 varies depending on the orientation (i.e., welding robot posture) of the spot welding gun 100. This is because a size or magnitude and direction of the minimum force vector reaction force are changed as the welding gun orientation of the spot welding gun 100 is changed. Therefore, minimum air pressures Pm1, Pm2, Pm3, and Pm4 for respective cases are changed.

In this case, the minimum force vector reaction force has a value of welding gun gravity*cost according to the law of sum of forces.

Therefore, as in CASES 1, 2, and 3, in case that the welding gun orientation is directed downward, the outputted exhaust pressure in P2 is higher than the input pressure in P1 inputted to the air balance cylinder 150.

In contrast, as in CASE 4, in case that the welding gun orientation is directed upward, the input pressure in P1 needs to be higher than the exhaust pressure in P2 in the air balance cylinder 150. This is because the welding gun lower part may be strongly lowered by gravity and the welding target 10 may be deformed in case that the input pressure in P1 is lower than the exhaust pressure in P2 when the welding gun orientation is directed upward as in CASE 4.

Therefore, in order to prevent the deformation of the welding reference surface by using the equalizing function according to an embodiment of the present disclosure, it is very important to provide a minimum force derivation method that changes the setting value depending on the welding gun orientation.

Therefore, as illustrated in FIG. 6, the welding quality manager 500 according to an embodiment of the present disclosure may derive the minimum air pressure Pm in consideration of the welding gun orientation as the input condition of the minimum force derivation feedback algorithm and store a setting value of the minimum air pressure Pm.

In addition, the welding quality manager 500 may automatically derive the minimum force F3 for each posture of the spot welding gun 100 by means of the minimum force derivation feedback algorithm and the piston position sensor 152 that monitors the operation of the air balance cylinder 150.

Therefore, a teaching operator in the related art may efficiently perform the equalizing setting operation by using the welding quality manager 500 without manually obtaining the minimum force.

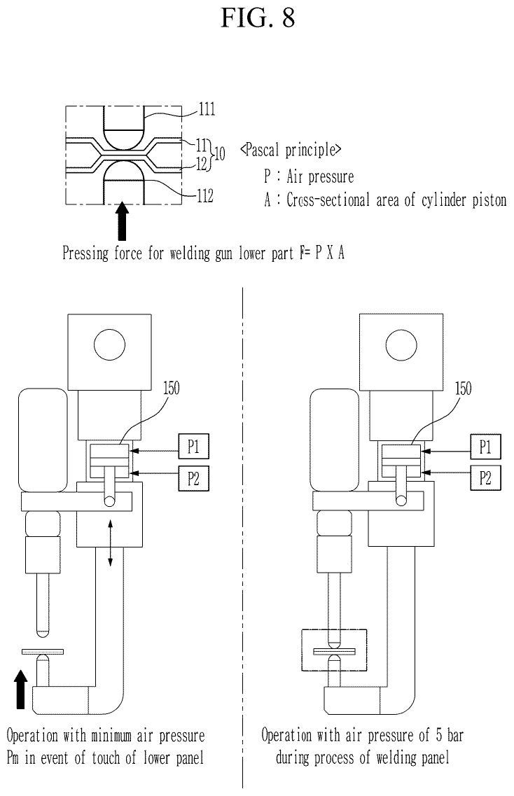

FIG. 8 is a view illustrating a method of controlling a pressing force for the welding gun lower part when the equalizing function according to an embodiment of the present disclosure is applied.

With reference to FIG. 8, in the air balance cylinder 150, the pressing force for the welding gun lower part adjusted by the electric proportional pressure control valve 151 is determined on the basis of the Pascal principle in consideration of air pressure P and an air cylinder piston cross-sectional area A.

The electric proportional pressure control valve 151 may adjust the air pressure input to the air balance cylinder 150 and operate by means of a solenoid valve in response to an electrical signal.

The electric proportional pressure control valve 151 may adjust a constant pressure in the cylinder by monitoring in real time the air pressure input to the air balance cylinder 150 and the output exhaust pressure by using a pressure sensor. The electric proportional pressure control valve 151 may maintain a constant pressing force or adjust a pressing force for each step during the welding process.

For example, in case that the second welding tip 112 is intended to be raised and touch the lower portion of the welding target 10, the electric proportional pressure control valve 151 may operate the air balance cylinder 150 by using the minimum air pressure Pm set by applying the equalizing function.

In addition, the electric proportional pressure control valve 151 may operate the balance cylinder 150 at an increased air pressure (e.g., 5 bar) in order to prevent the sagging of the second welding tip 112 during the process of spot welding the welding target 10.

The piston position sensor 152 has a sensor wire vertically installed inside the air balance cylinder 150 and detects whether the piston is moved by using a Hall effect generated between magnets 155 installed on the piston 154. In other words, the sensor wire of the piston position sensor 152 may detect whether the air balance cylinder 150 is moved by using the principle of detecting the Lorentz force generated by the Hall effect in accordance with the change in positions of the magnets 155 installed on the piston 154. In this case, it is apparent that whether the connected second welding tip 112 is moved upward or downward may be detected as the piston position sensor 152 detects whether the air balance cylinder 150 is moved.

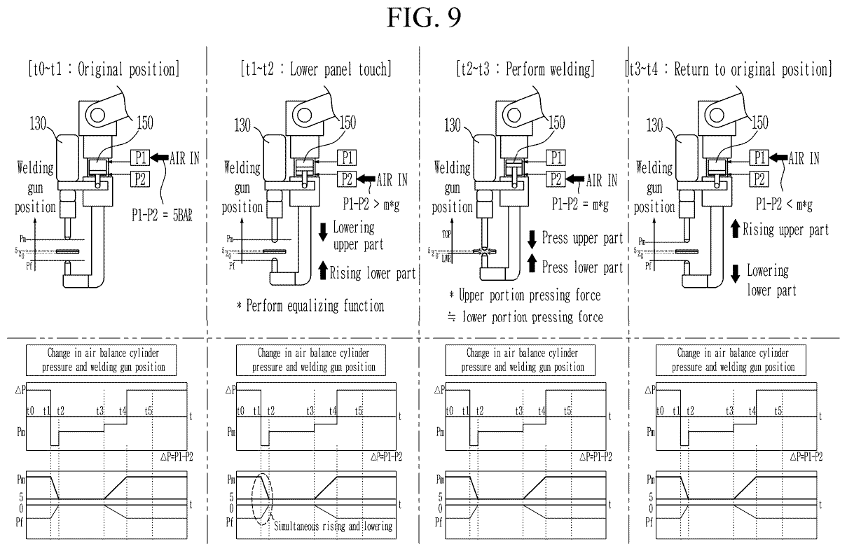

Meanwhile, FIG. 9 is a view illustrating a method of implementing an equalizing function for preventing deformation of a welding object during a spot welding process according to an embodiment of the present disclosure.

With reference to FIG. 9, the equalizing function according to an embodiment of the present disclosure may be controlled for each step (section) by the welding controller 400 during the welding process according to the time t in the state in which the spot welding gun 100 is moved to the welding point position of the welding target 10.

First, an original position step (t0 to t1) is described.

In case that the welding gun orientation is directed downward when the spot welding gun 100 is moved to the welding point position (original position) on the welding target 10 by the welding robot 200, the welding controller 400 maintains operating pressure (P1−P2) of the air balance cylinder 150 to a predetermined main pressure (e.g., 5 bar).

Next, a lower panel touch step (t1 to t2) is described.

The welding controller 400 performs the equalizing function for raising the welding gun lower part with the minimum force F3 by inputting the minimum air pressure Pm, which is set by the minimum force derivation feedback algorithm of the welding quality manager 500, to the air balance cylinder 150, and stopping the welding gun lower part when the welding gun lower part touches the lower portion of the welding target 10. At the same time, the welding controller 400 lowers the welding gun upper part by means of the welding gun pressing unit 130 until the welding gun upper part comes into contact with the welding target 10. In this case, the welding controller 400 may monitor the time point of the touch of the welding gun upper part and the welding gun lower part on the welding target 10 by detecting the motor torque reaction force detected by the servo motor of the welding pressing unit 130 configured to lower the welding gun upper part. Additionally, the welding controller 400 may monitor the time point of the touch of the welding gun upper part and the welding gun lower part by detecting the stop of the piston position sensor 152 installed on the air balance cylinder 150 configured to raise the welding gun lower part. In this case, the piston position sensor 152 may monitor the piston motion of the air balance cylinder 150 and detect the touch of the welding gun lower part on the welding target 10.

According to the equalizing function of the present disclosure, the panel is not deformed even though any one of the welding gun upper part and the welding gun lower part touches the welding target 10 first. For example, in case that the welding gun upper part touches the upper portion of the welding target 10 first, a reaction force generated by a welding gun upper part pressing force on the welding target 10 is not generated because the welding gun upper part only applies a pressing force on the welding target for a micro-time t because of the characteristics of the servo motor, such that the panel is not deformed. In addition, in case that the welding gun lower part touches the lower portion of the welding target 10 first, the minimum force F3 applied to the lower portion of the welding target 10 is very small because of a deviation between the welding gun lower part weight (m*g) and an overall force (ΔPm*A) by which the air balance cylinder raises the welding gun lower part, such that the panel is not deformed.

Next, a welding performing step (t2 to t3) is described.

When the welding controller 400 recognizes the time point at which the welding gun upper part and the welding gun lower part come into contact with each other, the welding controller 400 stops the raising of the welding gun lower part and changes the operating pressure (P1−P2) of the air balance cylinder 150 to the pressure equal to the lower welding gun weight (m*g). Further, the spot welding is performed by applying current in a bidirectional force equilibrium state in which the welding gun upper part and the welding gun lower part are operated by pressing forces with almost equal numerical values.

More specifically, during the welding process, the welding controller 400 begins to press the upper portion of the welding target 10 by lowering the welding gun upper part by means of the welding pressing unit 130. In this case, because the first welding tip 111 of the welding gun upper part presses the upper portion of the welding target 10 with a high pressing force of 200 kg or higher, the welding gun lower part may sag in a structure such as a cantilevered beam in the related art.

Therefore, the welding controller 400 of the present disclosure presses the two opposite portions of the welding target 10 in the force equilibrium state by increasing the operating pressure, by which the air balance cylinder 150 raises the welding gun lower part, in accordance with the upper portion pressing force of the welding pressing unit 130. In other words, when the welding gun upper part presses the upper portion of the welding target 10, the welding controller 400 may prevent the sagging of the welding gun lower part by maintaining the force equilibrium state by increasing the rising pressure (e.g., 5 bar) of the air balance cylinder 150 by means of the electric proportional pressure control valve 151.

Next, an original position returning step (t3 to t4) is described.

When the spot welding is completed, the welding controller 400 releases the welding gun holding by raising the welding gun upper part and lowering the welding gun lower part and returns the spot welding gun 100 to the original position or moves the spot welding gun 100 to the subsequent welding point position.

When the welding gun lower part is lowered, the welding controller 400 may perform control to make the operating pressure (P1−P2) of the air balance cylinder 150 lower than the welding gun lower part weight (m*g).

The first condition for preventing the deformation of the reference measurement surface of the welding part has been described.

Hereinafter, the mechanical part capable of measuring an accurate position without causing the sagging of the welding gun lower part of the spot welding gun 100 at the time of measuring the welding indentation depth in accordance with the second condition according to an embodiment of the present disclosure is described.

First, a description of why the second condition is necessary is briefly described.

Because the spot welding gun in the related art has a mechanical structure having a lower portion fixed in the form of a cantilevered beam, the welding gun lower part excessively sags as a moment of force is generated on the lower portion when the welding gun upper part is pressed by the pressing unit during the welding process. In addition, the pressing unit of the welding gun upper part has a structure in which a servo motor installed in parallel with a driving shaft is connected by a timing belt, and a ball screw is used to convert a rotational motion of the motor into a rectilinear motion to operate the driving shaft. However, there is a mechanical problem in that an encoder for data attached to a rear side of the servo motor cannot accurately measure the position of the driving shaft that moves rectilinearly because of many data measurement error-generating factors such as a change in tension of the timing belt, abrasion of the ball screw, and mechanical assembling tolerance.

Therefore, the spot welding gun 100 according to an embodiment of the present disclosure includes the welding pressing unit 130 and the linear guide unit 160 as the mechanical parts for precisely measuring the welding indentation depth of the welding target 10 during the welding process. The welding pressing unit 130 and the linear guide unit 160 are described more specifically with reference to the following drawings.

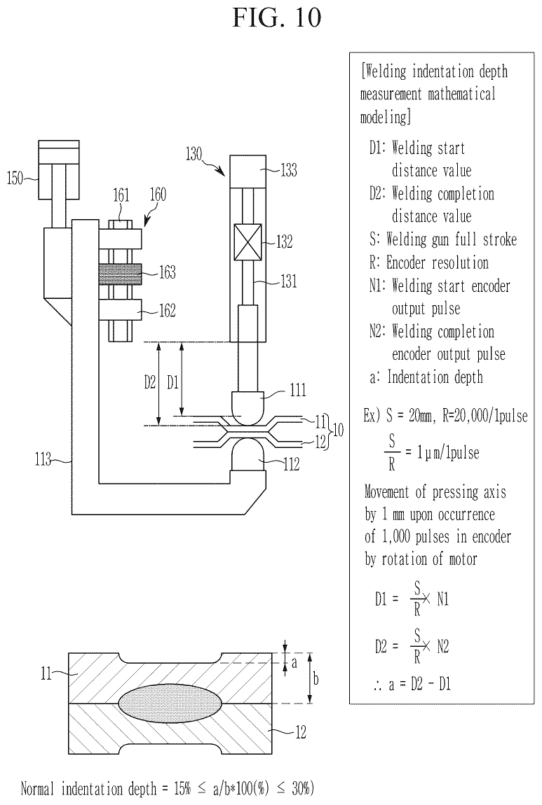

FIG. 10 is a view illustrating a configuration of the mechanical part for precisely measuring the welding indentation depth according to an embodiment of the present disclosure.

With reference to FIG. 10, the welding pressing unit 130 according to an embodiment of the present disclosure includes a roller screw 131 configured to convert a rotational motion of a magnetic type servo motor 132 into a rectilinear motion of a driving shaft 134, and an encoder 133 connected in series to a rear end of the driving shaft 134 and configured to precisely measure the position of the first welding tip 111 installed at a front end of the driving shaft.

The welding pressing unit 130 couples the roller screw 131, which transmits a force to the driving shaft 134 in the rectilinear direction, directly to the servo motor 132 and minimizes (≈ZERO) the occurrence of assembling tolerance and cumulative tolerance.

The encoder 133 may measure a distance D of the first welding tip 11 from the welding pressing unit 130 in accordance with the rectilinear movement of the directly connected driving shaft 134.

The welding pressing unit 130 precisely measures a welding indentation depth A of the welding target 10 during the welding process by using the encoder 133.

For example, with reference to a mathematical modeling example in FIG. 10, the welding pressing unit 130 measures a welding start distance value D1 and a welding completion distance value D2 in a state in which the first welding tip 11 touches the upper surface of the welding target 10 by using the encoder 133 during the welding process. Further, the welding indentation depth “a” may be calculated as a value made by subtracting D1 from D2. Substantially, D1 means a welding start position of the first welding tip 11, D2 means a welding completion position of the first welding tip 11, and the welding indentation depth “a” may be measured on the basis of a deviation between the two positions (D2−D1).

The welding pressing unit 130 transmits the measured welding indentation depth “a” to the welding controller 400. The welding controller 400, which receives the measured welding indentation depth “a”, may inspect whether a normal welding quality criterion is satisfied in consideration of a welding quality correlation on the basis of the welding indentation depth “a” and a thickness “b” of the welding target (upper panel).

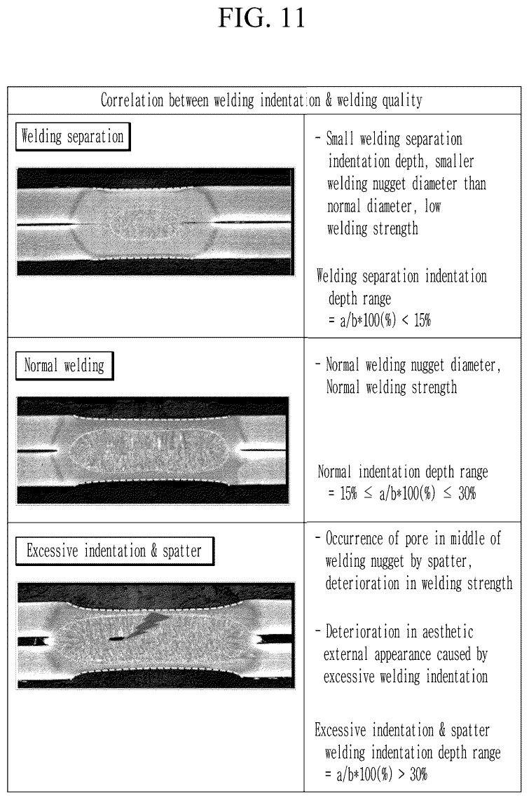

For example, FIG. 11 is a view illustrating a welding quality evaluation method according to a correlation between the welding indentation depth and the welding quality according to an embodiment of the present disclosure.

With reference to FIG. 11, the welding controller 400 may inspect whether the welding indentation depth “a”, which is made in consideration of the overall thickness “b” of the welding target, satisfies a preset first reference value (e.g., 15%=a/b*100(%)=30%). In this case, the first reference value includes a range of an upper limit value (30%) and a lower limit value (15%) of a normal indentation depth. The first reference value may be set by various experiments performed in consideration of a material, a thickness, a welding condition, and the like of the welding target or set through learning using a predesignated algorithm (e.g., simulation, program, and probability model).

For example, like normal welding, when the welding indentation depth “a” satisfies a range within the range of the first reference value (e.g., 15%=a/b*100(%)=30%), the welding controller 400 may determine that the welding nugget diameter and the welding strength are normal (OK).

In contrast, like welding separation, when the welding indentation depth “a” is less than the lower limit value of the first reference value (e.g., a/b*100(%)<15%), the welding controller 400 may determine that a welding separation defect (NG) occurs, in which a welding indentation depth and a welding nugget diameter are smaller than normal values, which causes deterioration in welding strength.

In addition, like excessive indentation & spatter, when the welding indentation depth “a” exceeds the upper limit value of the first reference value (e.g., a/b*100(%)>30%), the welding controller 400 may determine that an excessive spatter & welding defect (NG) occurs, in which welding strength decreases because of holes in a welding nugget caused by spatters, and a welding indentation depth is excessively larger than a normal value, which causes deterioration in aesthetic external appearance.

With reference back to FIG. 10, the linear guide unit 160 has a mechanical part that fixes the second welding tip 112 of the welding gun lower part by using the linear guide bearings 162 having a dual structure coupled to the linear guide rail 161, instead of a cantilevered beam fixing structure in the related art. Thereby a rotational motion caused by the rotational moment of force generated by the upper portion pressing force F1 during the welding process may be prevented.

In addition, the linear guide rail brake 163 is applied between the linear guide bearings 162 of the dual structure to prevent a vertical motion of the second welding tip 112 caused by the upper portion pressing force F1 during the welding process. Therefore, it is possible to provide support to precisely measure the welding indentation depth without an error by preventing the sagging of the second welding tip 112 during the spot welding process.

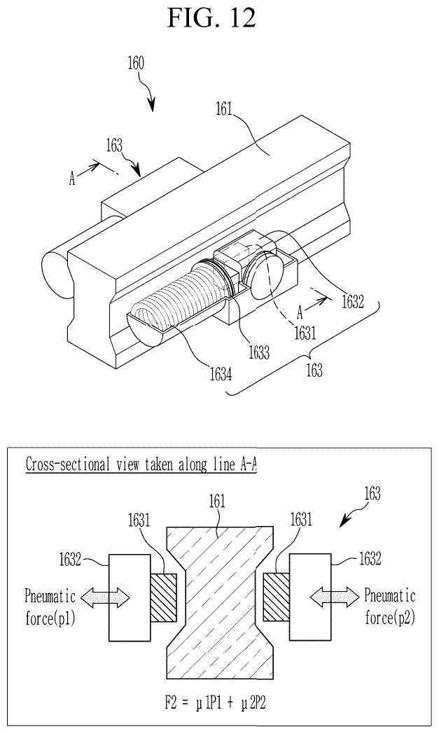

FIG. 12 is a view schematically illustrating a structure for operating a linear guide rail brake according to the embodiment of the present disclosure.

With reference to FIG. 12, the linear guide rail brake 163 includes friction member units 1631 configured to come into contact with two opposite sides of the linear guide rail 161 and configured to generate a braking force BK_F by friction, friction member sliding units 1632 configured to guide the friction member units 1631 in the direction of the linear guide rail 161, piston driving parts 1633 configured to apply brake pressure to the friction member units 1631, and origin returning units 1634 configured to return the friction member units 1631, which have completed the measurement of the welding indentation depth, to an origin by using springs.

Hereinafter, the sequence of the detailed operation of the linear guide rail brake 163 is described with reference to the cross-sectional view taken along line A-A.

The friction member units 1631 provided at two opposite sides based on the linear guide rail 161 generate the braking force BK_F by being slid forward horizontally by air pressures p1 and p2 introduced into air ports provided in the piston driving parts 1633. The braking force BK_F may fix the second welding tip 112 so that the second welding tip 112 of the lower part of the spot welding gun 100 does not sag or move in the rectilinear direction during the welding process.

In this case, the braking force BK_F applied to the linear guide rail may be set to a value calculated by using Equation 2 below.

$$BK\_F = μ 1 p 1 + μ 2 p 2 \qquad ( Equation 2 )$$

Here, μ1 and μ2 mean frictional coefficients of the respective friction member units, and p1 and p2 mean air pressure*piston cross-sectional area applied when the respective friction member units move forward.

The linear guide rail brake 163 securely fixes the welding gun lower part by setting the braking force BK_F to a value larger than the upper portion pressing force F1 made by the welding pressing unit 130 during the welding process (BK_F2>>F1), thereby preventing the sagging or motion of the second welding tip 112 of the welding gun lower part during the welding process (the process of measuring the welding indentation depth).

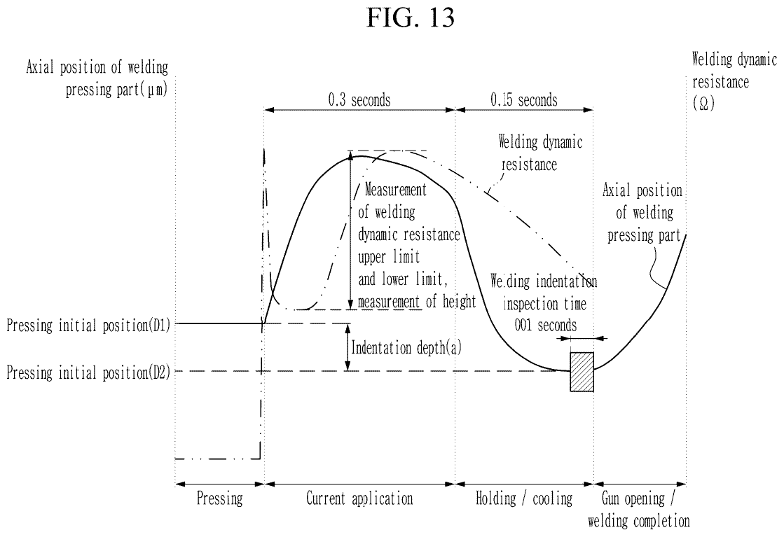

Meanwhile, FIG. 13 is a graph illustrating a method of inspecting welding quality in real time by using the spot welding gun according to an embodiment of the present disclosure.

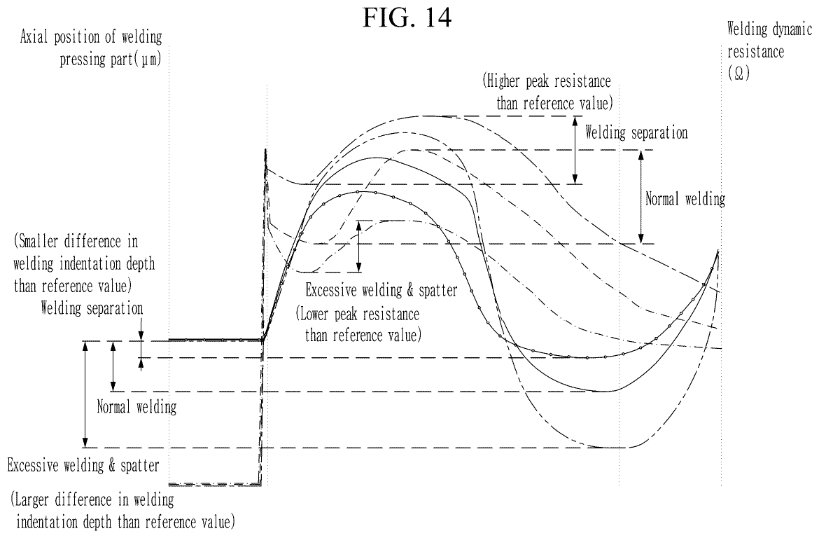

FIG. 14 is a view illustrating the comparison between dynamic resistance graphs and welding indentation depths in a normal welding state, a welding separation state, and an excessive spatter & welding state according to an embodiment of the present disclosure.

With reference to FIGS. 13 and 14, the welding controller 400 sets welding time for each welding step (e.g., welding gun pressing, current application, welding gun holding/cooling, and welding gun opening) at the time of setting the welding condition. Further, the welding quality is inspected in real time by collecting state data measured for a welding time and monitoring the welding indentation depth and the dynamic resistance during the actual welding process.

The welding controller 400 may measure the welding indentation depth “a” in accordance with an axial position of the welding pressing part for the inspection time in the welding gun holding step. In this case, as described above with reference to FIG. 11, the welding controller 400 may evaluate whether the normal welding quality criterion is satisfied in consideration of the welding quality correlation on the basis of the welding indentation depth “a” measured at the inspection time point.

In addition, the welding controller 400 measures a voltage from a welding gun current application time point and calculates real-time dynamic resistance by using Joule's law and Ohm's law. In this case, the welding controller 400 may predict the welding quality in accordance with the change in resistance of the welding part by detecting a dynamic resistance upper limit value, a lower limit value, and a height through a dynamic resistance graph according to the welding time t.

In this case, the welding controller 400 may inspect whether the dynamic resistance upper limit value Rp measured to the inspection time of the welding gun holding step satisfies a preset second reference value (e.g., 85%=Rp=120%). In this case, the second reference value includes a range of an upper limit value (120%) and a lower limit value (85%) of normal dynamic resistance during the welding process. The second reference value may be set by various experiments performed in consideration of a material, a thickness, a welding condition (resistance and current), and the like of the welding target or set through learning using a predesignated algorithm (e.g., simulation, program, and probability model).

For example, when the dynamic resistance upper limit value Rp satisfies a range within the range of the second reference value (e.g., 85%=Rp=120%), the welding controller 400 may determine that the welding nugget diameter and the welding strength are normal (OK).

In contrast, when the dynamic resistance upper limit value is less than the lower limit value of the second reference value (e.g., dynamic resistance upper limit value>85%), the welding controller 400 may determine that an excessive spatter & welding defect (NG) occurs, in which a panel thickness is decreased by spatters, and welding strength deteriorates because of the occurrence of holes in the welding part.

In addition, when the dynamic resistance upper limit value Rp exceeds the upper limit value of the second reference value (e.g., Rp>120%), the welding controller 400 determines that a welding separation defect (NG) occurs, in which the welding process is not completely performed, the panel thickness increases, and the welding nugget diameter is small, which causes deterioration in welding strength.

The welding controller 400 collects state data measured during the welding process and inspects welding quality in real time on the basis of the welding indentation depth and the dynamic resistance. When the reference value conditions are not satisfied, the welding controller 400 transmits the dissatisfaction to the welding quality manager 500 and requests the autonomous welding quality calibration. Further, it is possible to perform the autonomous welding quality calibration control by changing the initial welding condition on the basis of the welding condition feedback change received in response to the request from the welding quality manager 500.

Meanwhile, a method of autonomously calibrating welding quality by using the spot welding gun according to an embodiment of the present disclosure is described with reference to the configuration of the system 1 for autonomously calibrating welding quality by using the spot welding gun 100.

The welding controller 400 and the welding quality manager 500 may each be implemented as one or more processors configured to be operated by a preset program. The preset program may be programmed to perform the respective steps of the method of autonomously calibrating welding quality by using the spot welding gun according to an embodiment of the present disclosure.

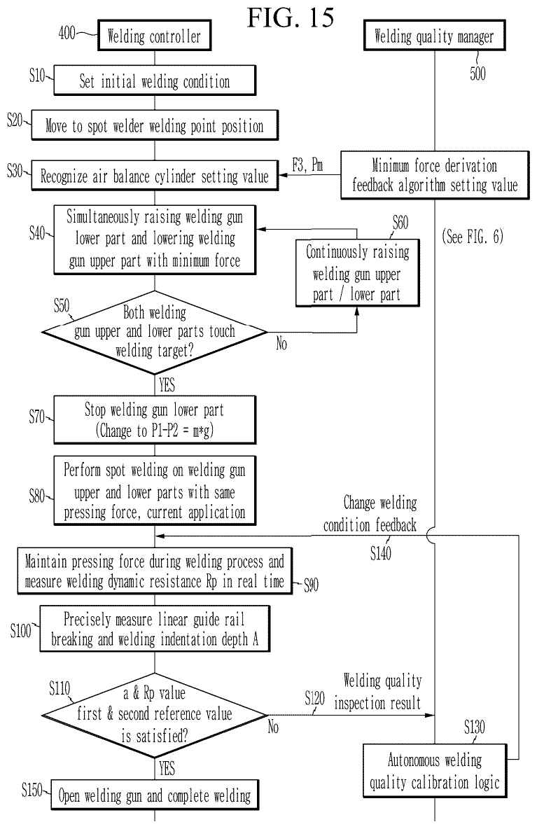

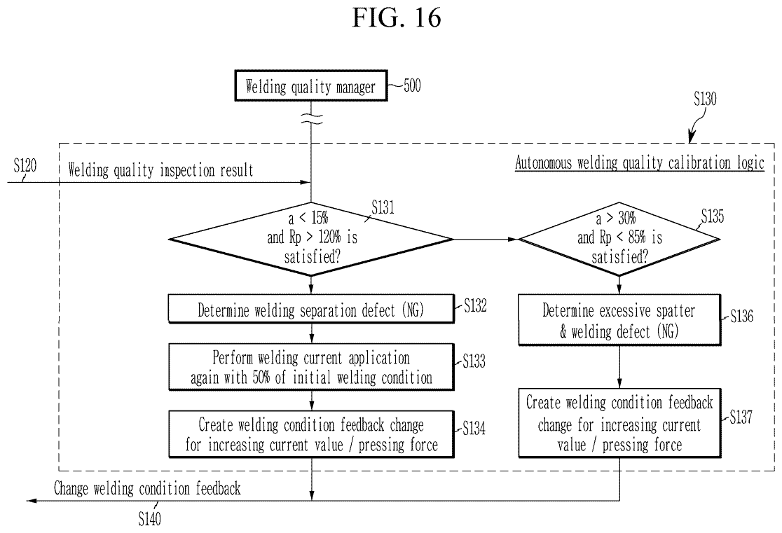

The method of autonomously calibrating welding quality by using the spot welding gun is described more specifically with reference to FIGS. 15 and 16 below.

FIG. 15 is a flowchart schematically illustrating a method of autonomously calibrating welding quality by using the spot welding gun according to an embodiment of the present disclosure.

With reference to FIG. 15, the welding controller 400 of the system 1 for autonomously calibrating welding quality by using the spot welding gun 100 according to an embodiment of the present disclosure sets an initial welding condition with respect to a designated welding point of the welding target 10 (S10). For example, the welding controller 400 may set a welding current value, a pressing force, and a welding time corresponding to input information such as a welding point ID of the welding target 10 and a material and thickness of the upper panel.

The welding controller 400 moves the spot welding gun 100 to the designated welding point position by means of the welding robot 200 (S20).

The welding controller 400 recognizes the minimum force F3 and the minimum air pressure Pm of the air balance cylinder 150 according to the welding point position and the welding gun orientation (posture) with reference to the setting value set by the welding quality manager 500 to prevent the deformation of the welding part (i.e., to implement the equalizing function) (S30). In this case, the setting value is a preset value derived in advance by means of the minimum force derivation feedback algorithm of the welding quality manager 500 (see FIG. 6).

The welding controller 400 supplies the Pm pressure to the air balance cylinder 150 to simultaneously raise the welding gun lower part with the minimum force F3 and lower the welding gun upper part by means of the welding gun pressing unit 130, thereby moving the welding gun lower part and the welding gun upper part until the welding gun lower part and the welding gun upper part come into contact with each other with the welding target 10 interposed therebetween (S40).

In this case, the welding controller 400 monitors the motion of the welding gun upper part and the motion of the welding gun lower part and recognizes whether both the welding gun upper part and the welding gun lower part touch the welding target 10 (S50). When the welding controller 400 detects that the motor torque reaction force is generated by the servo motor of the welding pressing unit 130, the welding controller 400 recognizes that the welding gun upper part touches the upper portion of the welding target 10. In addition, when the welding controller 400 may recognize that the welding gun lower part touches the lower portion of the welding target 10 by detecting that motion of the piston stops by the piston position sensor 152 installed on the air balance cylinder 150.

When the welding gun upper part or the welding gun lower part do not touch the welding target 10 (S50; NO), the welding controller 400 consistently lowers the welding gun upper part or raises the welding gun lower part that does not touch the welding target 10 (S60).

In contrast, at the time point at which the welding controller 400 recognizes that both the welding gun upper part and the welding gun lower part touch the welding target 10 (S50; YES), the welding controller 400 stops the raising of the welding gun lower part and changes the operating pressure (P1−P2) of the air balance cylinder 150 to a pressure equal to the lower welding gun weight (m*g) (S70).

The welding controller 400 performs the spot welding by applying current in the bidirectional force equilibrium state in which the pressing force for the welding gun lower part is increased to be equal to the pressing force for the welding gun upper part (S80).

The welding controller 400 measures the welding current and the dynamic resistance R in real time while maintaining the pressing force for the welding gun upper part and the pressing force for the welding gun lower part during the welding process using the spot welding gun 100 (S90).

In addition, the welding controller 400 operates the linear guide rail brake 163 for preventing the sagging of the welding gun lower part at the inspection time point after the completion of the welding holding, and the welding controller 400 precisely measures the welding indentation depth “a” using the encoder 133 connected directly to the rear side of the welding pressing unit 130 (S100). The welding indentation depth “a” may be calculated by subtracting the welding start distance value D1, which indicates that the welding gun upper part touches the upper portion of the welding target 10 from the reference position of the welding pressing unit 130, from the welding completion distance value D2.

The welding controller 400 inspects the welding quality by determining whether the welding indentation depth “a” measured during the welding process satisfies the first reference value (e.g., 15%=a/b*100(%)=30%) set to the normal range made in consideration of the welding target thickness and whether the dynamic resistance upper limit value Rp satisfies the second reference value (e.g., 85%=Rp=120%) set to the normal dynamic resistance range (S110).

In this case, when the welding indentation depth “a” and the dynamic resistance upper limit value Rp satisfy the first reference value and the second reference value (S110; YES), the welding controller 400 opens the upper and lower parts of the welding gun and completes the welding process on the corresponding welding point (S150).

In contrast, when the welding indentation depth “a” and the dynamic resistance upper limit value Rp do not satisfy the preset first reference value and the preset second reference value (S110; NO), the welding controller 400 transmits the welding quality inspection result to the welding quality manager 500 and requests the autonomous welding quality calibration (S120).

When the welding quality manager 500 receives the welding quality inspection result from the welding controller 400 (S120), the welding quality manager 500 analyzes the received welding quality inspection result by executing the autonomous welding quality calibration logic (S130).

The welding quality manager 500 determines the welding separation defect (NG) or the excessive spatter & welding defect (NG) on the basis of the analysis, creates a welding condition feedback change message for changing at least one of the current value, the pressing force, and the welding time to cope with the defect, and transmits the welding condition feedback change message to the welding controller 400 (S140).

Therefore, the welding quality manager 500 may manage the welding controller 400 so that the welding controller 400 performs the autonomous welding quality control using the spot welding gun 100.

Meanwhile, FIG. 16 is a flowchart schematically illustrating the autonomous welding quality calibration logic of the welding quality manager according to an embodiment of the present disclosure.

With reference to FIG. 16, the autonomous welding quality calibration logic according to an embodiment of the present disclosure may be described as specifying step S130 in FIG. 15.

The welding quality manager 500 analyzes the welding quality inspection result received from the welding controller 400 (S130).

In this case, when the state in which the welding indentation depth “a” is less than the lower limit value of the first reference value (e.g., a<15%) and the dynamic resistance upper limit value Rp exceeds the upper limit value of the second reference value (e.g., Rp>120%) is satisfied (S131; YES), the welding quality manager 500 determines that the welding separation defect (NG) occurs. When the welding separation defect (NG) occurs, the welding indentation depth and the welding nugget diameter are smaller than the normal values, which causes deterioration in welding strength (S132).

Therefore, on the basis of the determination of the welding separation defect, the welding quality manager 500 performs again the welding current application with 50% of the initial welding condition (e.g., with 50% of the welding current, 50% of the welding time, and/or 50% of a welding pressing force) (S133) and creates a welding condition feedback change message for increasing at least one of the current value and the pressing force (S134). Further, the welding quality manager 500 may transmit the created welding condition feedback change message to the welding controller 400 (S140). Therefore, the welding controller 400 may cope with a subsequent welding separation defect (NG) by controlling the autonomous welding quality calibration that changes the welding condition in accordance with the welding condition feedback change.

In addition, in case that step S131 is not satisfied (S131; NO), the welding quality manager 500 may determine that the excessive spatter & welding defect (NG) occurs (S136) when the state in which the welding indentation depth “a” exceeds the upper limit value of the first reference value (e.g., a>30%) and the dynamic resistance upper limit value Rp is less than the lower limit value of the second reference value (e.g., Rp<85%) is satisfied (S135; YES).

Therefore, the welding quality manager 500 creates a welding condition feedback change message for decreasing at least one of the current value, the pressing force, and the welding time as a response to the excessive spatter & welding defect (NG) (S137). Further, the welding quality manager 500 may transmit the created welding condition feedback change message to the welding controller 400 (S140). Therefore, the welding controller 400 may cope with a subsequent excessive spatter & welding defect (NG) by controlling the autonomous welding quality calibration that changes the welding condition in accordance with the welding condition feedback change.

However, the welding quality manager 500 may manage and instruct the welding controller 400 to stop the welding process without performing the welding process again on the welding target 10 that already has the excessive spatter & welding defect (NG), such that the welding target 10 enters an external appearance quality repair process.

As described above, according to an embodiment of the present disclosure, the welding quality may be inspected in real time by precisely measuring the dynamic resistance and the welding indentation depth by using the spot welding gun during the welding process, and the autonomous calibration may be performed on the changed welding quality, thereby preventing a product defect and improving reliability of welding quality.

In addition, it is possible to prevent deformation of a welding reference surface, which is caused by a material and equipment, by using the linear guide unit and the air balance cylinder of the spot welding gun and using the equalizing function for moving the welding gun lower part in the rectilinear upward/downward direction.

In addition, the spot welding gun is provided with the linear guide rail brake for preventing the welding gun lower part from sagging during a welding process, and the spot welding gun is provided with the encoder directly applied to the driving shaft of the welding pressing unit, which makes it possible to precisely measure the welding indentation depth in real time during the welding process.

The embodiments of the present inventive concept disclosed herein may be implemented by other apparatuses and/or methods and are not to be construed as limited to being implemented by the apparatuses and methods described above. Based on the above-mentioned descriptions of the embodiments, those of ordinary skill in the art to which the present disclosure pertains may readily implement the embodiments through programs for realizing the functions corresponding to the configurations of the embodiments of the present disclosure or through recording (e.g., computer readable) media on which the programs are recorded.

Although embodiments of the present disclosure have been described in detail above, the scope of the present disclosure is not limited thereto. It should be construed that many variations and modifications made by those of ordinary skill in the art using the basic concept of the present disclosure, which is defined in the following claims, are also included in the scope of the present disclosure.

### DESCRIPTION OF SYMBOLS

| | |
|---|---|
| 10: Welding target | 11: Upper panel |
| 12: Lower panel | 1: System for autonomously calibrating welding quality |
| 100: Spot welding gun | 111: First welding tip |
| 112: Second welding tip | 113: Gun body |
| 120: Robot mounting bracket | 130: Welding pressing unit |
| 131: Roller screw | 132: Servo motor |
| 133: Encoder | 134: Driving shaft |
| 140: Welding transformer | |
| 150: Air balance cylinder | 151: Electric proportional pressure control valve |
| 152: Piston position sensor | 153: Pressure detection sensor |
| 154: Piston | 155: Magnet |
| 160: Linear guide unit | 161: Linear guide rail |
| 162: Linear guide bearing | 163: Linear guide rail brake |
| 1631: Friction member unit | 1632: Friction member sliding unit |
| 1633: Piston driving part | 1634: Origin returning unit |
| 170: Cooling unit | |
| 200: Welding robot | 300: Air compressor |
| 400: Welding controller | 500: Welding quality manager |

What is claimed is:

1. A spot welding gun for autonomously calibrating welding quality, the spot welding gun comprising:
a first welding tip on a welding gun upper part and a second welding tip on a welding gun lower part;
a robot mounting bracket configured to mount the first welding tip and the second welding tip on a welding robot;
a welding pressing unit configured to press a welding target by using compressed air supplied from an air compressor and precisely measure a welding indentation depth of a welding part by using an encoder connected directly to a rear side of the welding pressing unit during a welding process;
a welding transformer configured to supply high current required during the welding process;
an air balance cylinder configured to prevent deformation of a reference measurement surface of the welding part by implementing an equalizing function for moving the second welding tip in a rectilinear upward/downward direction by using the compressed air; and
a linear guide unit configured to assist a rectilinear upward/downward movement of the second welding tip.

2. The spot welding gun of claim 1, wherein the air balance cylinder performs the equalizing function for raising or lowering the welding gun lower part using a minimum force until the second welding tip of the welding gun lower part touches the welding target when the welding target is higher or lower than a reference height.

3. The spot welding gun of claim 1, wherein the air balance cylinder comprises:
an electric proportional pressure control valve configured to adjust, by using a piston, a main pressure of the compressed air to a low pressure corresponding to the minimum force by which whether the rising second welding tip touches a lower portion of the welding target is recognized;
a piston position sensor configured to monitor a motion of the piston and recognize whether the second welding tip touches the welding target; and
a pressure detection sensor configured to support feedback control for minimum force derivation by transmitting pressures, which are measured using first and second ports P1 and P2 embedded in the air balance cylinder, to the electric proportional pressure control valve.

4. The spot welding gun of claim 3, wherein the pressure detection sensor measures air pressure introduced into the air balance cylinder through the P1 and measures exhaust pressure discharged to the outside through the P2, and the pressure detection sensor provides feedback to the electric proportional pressure control valve.

5. The spot welding gun of claim 3, wherein the electric proportional pressure control valve receives feedback related to the air pressure in the P1 and the exhaust pressure in the P2 and controls the movement of the second welding tip with the derived minimum force, and wherein the electric proportional pressure control valve stops the movement of the second welding tip when it is detected by the piston position sensor that movement of the piston has stopped.

6. The spot welding gun of claim 3, wherein the piston position sensor has a sensor wire vertically installed inside the air balance cylinder and detects whether the piston is moved by using a Hall effect generated between magnets installed on the piston.

7. The spot welding gun of claim 1, wherein the welding pressing unit comprises:
a roller screw configured to convert a rotational motion of a magnetic type servo motor into a rectilinear motion of a driving shaft; and
an encoder connected in series to a rear end of the driving shaft and configured to precisely measure a position of the first welding tip installed at a tip of the driving shaft.

8. The spot welding gun of claim 7, wherein the encoder measures a distance D of the first welding tip from the welding pressing unit in accordance with the rectilinear movement of the directly connected driving shaft, a welding start distance value D1 and a welding completion distance value D2 are measured in a state in which the first welding tip touches an upper surface of the welding target, and the welding indentation depth is calculated as a value made by subtracting D1 from D2.

9. The spot welding gun of claim 1, wherein the linear guide unit comprises:
a linear guide rail provided in the rectilinear upward/downward direction;
a linear guide bearing having a dual structure and configured to move the second welding tip along the linear guide rail; and
a linear guide rail brake configured to fix a position of the second welding tip to precisely measure the welding indentation depth.

10. The spot welding gun of claim 9, wherein the linear guide rail brake comprises:
friction member units configured to come into contact with two opposite sides of the linear guide rail and generate a braking force by friction;
friction member sliding units configured to guide the friction member units in a direction of the linear guide rail;
piston driving parts configured to apply brake pressure to the friction member units; and
origin returning units configured to return the friction member units, which have completed the measurement of the welding indentation depth, to an origin using springs.

11. The spot welding gun of claim 9, wherein
the linear guide rail brake securely fixes the welding gun lower part by setting the braking force to a value higher than an upper portion pressing force generated by the welding pressing unit during the welding process.

12. A system for autonomously calibrating welding quality by using a spot welding gun, the system comprising:
a spot welding gun configured to constitute a mechanical part that fixes a welding target during a welding process so that a reference measurement surface of a welding part is not deformed, the spot welding gun being configured to precisely measure a welding indentation depth and perform autonomous welding quality calibration in response to an applied control signal;
a welding robot equipped with the spot welding gun and configured to move to a designated welding point position;
an air compressor configured to supply high-pressure compressed air for pressing the welding part of the spot welding gun;
a welding controller configured to control a welding current and a welding time of the spot welding gun on the basis of an initial welding condition and inspect welding quality in real time by monitoring the welding indentation depth and dynamic resistance measured by the spot welding gun during the welding process; and
a welding quality manager configured to receive a welding quality inspection result from the welding controller, to transmit a welding condition feedback change according to dissatisfaction of reference value conditions of the welding indentation depth and the dynamic resistance, and to control the autonomous welding quality calibration.

13. The system of claim 12, wherein the welding quality manager stores a minimum force and a minimum air pressure as setting values in consideration of a welding gun orientation of the spot welding gun, which varies depending on a plurality of welding point positions set to the welding target, by using a minimum force derivation feedback algorithm for implementing an equalizing function for moving a welding gun lower part in a rectilinear upward/downward direction.

14. The system of claim 12, wherein the welding controller simultaneously raises the welding gun lower part with a minimum force and lowers a welding gun upper part by means of a welding gun pressing unit to move the welding gun lower part and the welding gun upper part until the welding gun lower part and the welding gun upper part come into contact with each other with the welding target interposed therebetween by inputting a minimum air pressure, which is set by the welding quality manager, to an air balance cylinder, and wherein the welding controller presses upper and lower portions of the welding target in a force equilibrium state by increasing an operating pressure, by which the air balance cylinder raises the welding gun lower part, in accordance with an upper portion pressing force of the welding pressing unit.

15. The system of claim 14, wherein the welding controller measures a welding current and a dynamic resistance R in real time while maintaining a pressing force for the welding gun upper part and a pressing force for the welding gun lower part during the welding process using the spot welding gun, and wherein the welding controller measures a welding indentation depth by subtracting a welding start distance value D1, which indicates that the welding gun upper part touches an upper portion of the welding target, from a welding completion distance value D2.

16. The system of claim 15, wherein when the welding indentation depth and a dynamic resistance upper limit value do not satisfy a preset first reference value and a preset second reference value, the welding controller determines that a welding separation defect (NG) or an excessive spatter and welding defect (NG) occurs, the welding controller transmits a welding quality inspection result to the welding quality manager, and the welding controller changes at least one welding condition among a current value, a pressing force, and a welding time according to a welding condition feedback change of the welding quality manager.

17. The system of claim 16, wherein, in the event of the welding separation defect (NG), the welding quality manager performs a welding current application again with 50% of the initial welding condition and transmits a welding condition feedback change message for increasing at least one of the current value and the pressing force to the welding controller, and wherein in the event of the excessive spatter and welding defect (NG), the welding quality manager transmits a welding condition feedback change message for decreasing at least one of the current value, the pressing force, and the welding time to the welding controller.

18. A method of autonomously calibrating welding quality by using a spot welding gun, the method comprising:
moving, by a welding controller, a spot welding gun to a designated welding point position by means of a welding robot, and simultaneously raising a welding gun lower part with a minimum force by inputting a minimum air pressure to an air balance cylinder and lowering a welding gun upper part by means of a welding gun pressing unit to move the welding gun lower part and the welding gun upper part come into contact with each other with a welding target interposed therebetween;
pressing, in a welding step, upper and lower portions of the welding target in a force equilibrium state by increasing an operating pressure, by which the air balance cylinder raises the welding gun lower part, in accordance with an upper portion pressing force of the welding pressing unit;
measuring a welding current and dynamic resistance in real time while pressing the welding gun upper part during a welding process, and precisely measuring a welding indentation depth by using an encoder connected directly to a rear side of the welding pressing unit;
transmitting a welding quality inspection result to a welding quality manager and requesting autonomous welding quality calibration when the welding indentation depth and a dynamic resistance upper limit value do not satisfy a preset first reference value and a preset second reference value; and
analyzing, by the welding quality manager, the welding quality inspection result and transmitting a welding condition feedback change message, which corresponds to a welding separation defect (NG) or an excessive spatter and welding defect (NG), to a welding controller.

19. The method of claim 18, wherein:
the welding quality manager performs a minimum force derivation feedback algorithm for an equalizing function for moving the welding gun lower part in a rectilinear upward/downward direction; and
the minimum force derivation feedback algorithm includes
inputting, by the welding quality manager, a welding gun lower part weight and a welding gun orientation with respect to a designated welding point,
inputting a minimum air pressure of the air balance cylinder corresponding to the welding gun lower part weight and monitoring whether the air balance cylinder operates by means of a piston position sensor,
determining that the welding gun lower part cannot be moved when a motion is not detected by the piston position sensor and increasing air pressure to a predetermined level,
determining current air pressure to a minimum air pressure Pm by which the welding gun lower part is movable when the motion is detected by the piston position sensor, and
setting the minimum air pressure Pm and a minimum force of the welding gun lower part according to the welding point position and a spot welding gun orientation condition as a setting value and storing the setting value.

20. The method of claim 18, wherein analyzing the welding quality inspection result comprises:
determining that the welding separation defect (NG) occurs when the welding indentation depth is less than a lower limit value of the first reference value and the dynamic resistance upper limit value exceeds an upper limit value of the second reference value, performing a welding current application again with 50% of an initial welding condition, and creating a welding condition feedback change message for increasing at least one of a current value and a pressing force; and
determining that the excessive spatter & welding defect (NG) occurs when the welding indentation depth exceeds an upper limit value of the first reference value and the dynamic resistance upper limit value is less than a lower limit value of the second reference value and creating a welding condition feedback change message for decreasing at least one of the current value, the pressing force, and a welding time.
